(19) United States
(12) Patent Application Publication
(10) Pub. No.: US 2008/0168163 A1
(43) Pub. Date: Jul. 10, 2008

(54) INFORMATION PROCESSING DEVICE ASSIGNMENT METHOD, INFORMATION PROCESSING SYSTEM AND MANAGEMENT SERVER

(76) Inventor: Koichi KUROKAWA, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/956,660

(22) Filed: Dec. 14, 2007

(30) Foreign Application Priority Data
Dec. 19, 2006 (JP) 2006-340666

(51) Int. Cl. G06F 15/173

(52) U.S. Cl. 709/223

(57) ABSTRACT

A management server connected to information processing devices and terminals via a network includes a first storage unit for storing state information of assignment of the information processing devices to the terminals, a second storage unit for storing condition information of assignment of the information processing devices to the terminals, and an information processing unit responsive to reception of an information processing device assignment request from one of the terminals via the network, for determining an information processing device to be assigned to the assignment requesting terminal based on information stored in the first and second storage units in response to the request, transmitting destination information of the determined information processing device to the terminal via the network, and updating a state of assignment of the information processing device to a terminal stored in the first storage unit from an unassigned state to a state indicating assignment to the terminal.

### INCORPORATION BY REFERENCE

The present application claims priority from Japanese application JP2006-340666 filed on Dec. 19, 2006, the content of which is hereby incorporated by reference into this application.

### BACKGROUND OF THE INVENTION

The present invention relates to an information processing system including a plurality of information processing devices and terminals connected to each other via a network, and in particular to a technique for assigning information processing devices to terminals.

In recent years, adoption of the information processing systems of the so-called thin client type is advanced in enterprises mainly from the viewpoint of information leak prevention. As a technique relating to the information processing system, for example, a technique disclosed in JP-A-2003-337672 is known. In the information processing system of the thin client type, various application programs and data can be utilized by exercising remote control over information processing devices installed in a server room or an information center by using a terminal at hand. The risk of information leak caused by, for example, theft of a terminal can be reduced by using a PC (Personal Computer) of so-called HDD (Hard Disk Drive) less type. As the information processing devices, blade PCs obtained by designing an ordinary PC so as to have a blade size and an increased degree of integration per unit area, or server computers (hereafter referred to as virtual PC servers) each of which spuriously provide a PC environment (hereafter referred to as virtual PC) by using software are typically used.

### SUMMARY OF THE INVENTION

When the virtual PC server is used in the information processing system of the thin client type, it is efficient from the viewpoint of operation easiness of a manager, the degree of integration of clients per installation area, and effective resource utilization, and an effect of TCO (Total Cost of Ownership) reduction can be anticipated. However, a plurality of users share the same virtual PC server. If the number of users using the same virtual PC server increases, therefore, the performance is degraded in some cases.

On the other hand, when the blade PCs are used in the information processing system of the thin client type, resources are independent in the same way as the conventional PCs. Therefore, the performance is not degraded under the influence of the utilization situation of other users. On the other hand, it is disadvantageous as compared with the case where the virtual PC servers are used, from the viewpoint of operation easiness of a manager, the degree of integration per installation area, and effective resource utilization.

The above-described merits and demerits are problems in the technical aspect. However, they are not necessarily one-sided when seen from the aspect of operation. If the blade PCs and the virtual PC servers are provided mixedly and assignment of the information processing can be controlled so as to, for example, assign a blade PC to a user who needs an independent environment and resource and assign a virtual PC server to a user who needs only utilization of simple OA business and web system, the TCO reduction effect can be anticipated. In the above-described conventional technique, however, a technique of controlling such assignment of information processing devices is not disclosed.

The present invention has been made in view of the above-described circumstances. It is an object of the present invention to provide a technique of installing blade PCs and virtual PC servers mixedly and controlling assignment of them to terminals.

The object is achieved in accordance with the present invention by an information processing system including a plurality of information processing devices, a management server for managing the information processing devices, and a plurality of terminals, which are connected to each other via a network,

wherein the management server includes a first storage unit for storing state information of assignment of the information processing devices to the terminals, a second storage unit for storing condition information of assignment of the information processing devices to users of the terminals, an assignment request reception unit for receiving an information processing device assignment request from one of the terminals via the network, an information processing device determination unit for determining an information processing device to be assigned to the terminal of assignment request origin on the basis of state information of assignment of the information processing devices to the terminals stored in the first storage unit and condition information of assignment of the information processing devices to users of the terminals stored in the second storage unit in response to the received assignment request, a destination information transmission unit for transmitting destination information of the information processing device determined by the information processing device determination unit to the terminal of assignment request origin via the network, and an assignment state update unit for updating a state of assignment of the information processing device to a terminal stored in the first storage unit from an unassigned state to a state indicating assignment to the terminal of assignment request origin, and

each of the terminals includes an assignment request transmission unit for transmitting the information processing device assignment request to the management server via the network, a destination information reception unit for receiving destination information of the information processing device assigned to the terminal from the management server via the network, and a communication unit for communicating with the information processing device having the destination information by using the destination information received by the destination information reception unit, and

each of the information processing devices includes a communication unit for communicating with the terminal to which the destination information of the information processing device has been transmitted from the management server via the network.

In accordance with the present invention, each of the information processing devices further includes a supervision unit for supervising a utilization situation of the information processing device, and a utilization situation data transmission unit for transmitting utilization situation data obtained as a result of the supervision conducted by the supervision unit to the management server via the network, and

the management server further includes a utilization situation data reception unit for receiving the utilization situation data from the information processing device, and a third storage unit for storing the utilization situation data received by the utilization situation data reception unit.

In accordance with the present invention, the management server further includes an assignment condition change unit for changing conditions of assignment of the information processing devices to users of the terminals stored in the second storage unit on the basis of the utilization situation data stored in the third storage unit and predetermined reference values.

According to the present invention, the number of prepared blade PCs can be held down to a definite number and consequently the TCO can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of a schematic configuration of an information processing system according to the present invention;

FIG. 2 is a diagram showing a schematic configuration example of a management server 3;

FIG. 3 is a diagram showing a configuration example of a user information management table 245;

FIG. 4 is a diagram showing meaning of assignment conditions;

FIG. 5 is a diagram showing a configuration example of a blade PC assignment state management table 247;

FIG. 6 is a diagram showing a configuration example of a virtual PC server management table 248;

FIG. 7 is a diagram showing a configuration example of a virtual PC assignment state management table 249;

FIG. 8 is a diagram showing a configuration example of a utilization situation management table 250;

FIG. 9 is a diagram showing a configuration example of an assignment condition classification reassignment decision table 251;

FIG. 10 is a diagram showing a schematic configuration example of a blade PC 1;

FIG. 11 is a diagram showing a schematic configuration example of a virtual PC server 2;

FIG. 12 is a diagram showing a schematic configuration example of an active directory server 4;

FIG. 13 is a diagram showing a schematic configuration example of a terminal 6;

FIG. 14 is a diagram showing a schematic configuration example of an authentication device 7;

FIG. 15 is a diagram showing operation of the whole information processing system;

FIG. 16 is a diagram showing operation of the whole information processing system in the same way;

FIG. 17 is a flow chart showing detailed processing of assignment of the blade PC 1 or the virtual PC server 2 in the management server 3;

FIG. 18 is a flow chart showing detailed processing of assignment of the blade PC 1 or the virtual PC server 2 in the management server 3 in the same way;

FIG. 19 is a flow chart showing processing of an assignment condition classification reassignment decision; and

FIG. 20 is a diagram showing an example of a screen used by a manager to confirm users' utilization situation of information processing devices.

### DESCRIPTION OF THE EMBODIMENTS

Hereafter, an embodiment of the present invention will be described.

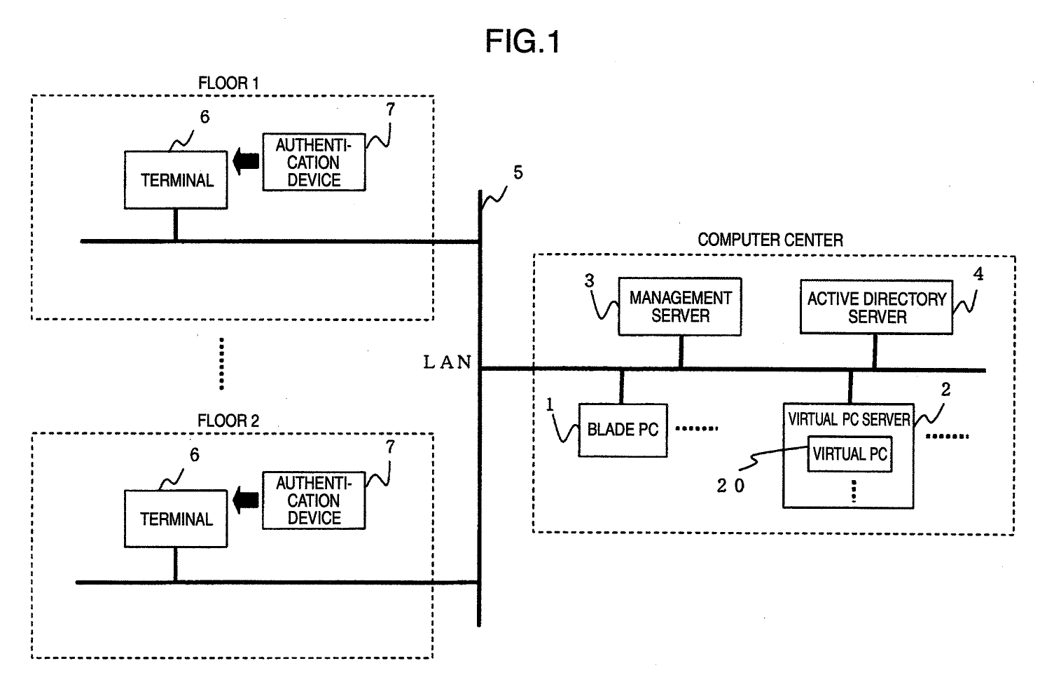

FIG. 1 is a diagram showing an example of a schematic configuration of an information processing system according to an embodiment of the present invention.

As shown in FIG. 1, the information processing system according to the present embodiment includes a plurality of information processing devices (a plurality of blade PCs 1 and virtual PC servers 2), a management server 3, an active directory server 4, a plurality of terminals 6, and a plurality of authentication devices 7. The blade PCs 1, the virtual PC servers 2, the management server 3, the active directory server 4 and the terminals 6 are connected to a network 5 such as a LAN (Local Area Network). The authentication device 7 can be attached to and detached from the terminal 6.

Although details will be described later, the management server 3 has a function of conducting user authentication by using authentication information (a user ID and a password) contained in an information processing device assignment request and authentication information (a user ID and a password) stored in an HDD beforehand in response to the information processing device assignment request supplied from the terminal 6, a function of making a decision whether information processing device to be assigned is a blade PC 1 or a virtual PC server 2 on the basis of the ratio of blade PCs 1 that are not yet assigned and condition information of assignment of information processing devices to users of terminals 6 stored in the HDD (storage unit) beforehand, a function of giving a notice of destination information of the assigned blade PC 1 or virtual PC server 2 to the terminal 6 of assignment request origin, a function of making a decision as to classification reassignment of information processing device assignment condition, and a function of updating information in relating tables on the basis of the decision result of the assignment and the decision result of the classification reassignment of the assignment condition.

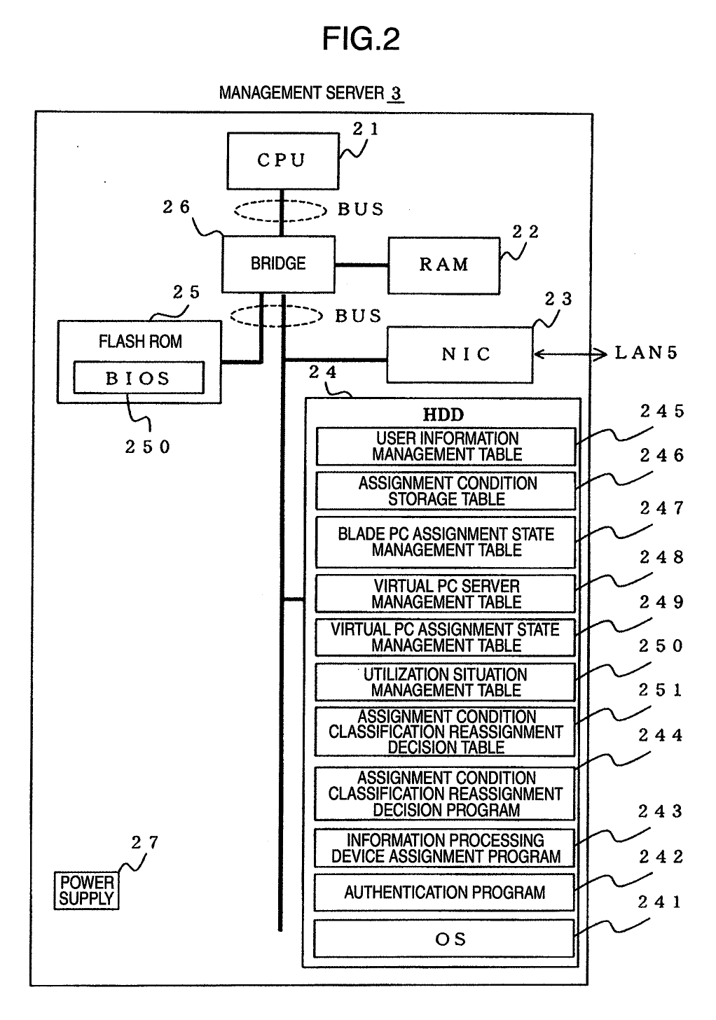

FIG. 2 is a diagram showing a schematic configuration example of the management server 3.

As shown in FIG. 2, the management server 3 includes a CPU (Central Processing Unit) 21, a RAM (Random Access Memory) 22 functioning as a work area for the CPU 21, a NIC (Network Interface Card) 23 for connection to the LAN 5, a HDD (Hard Disk Drive) 24, a flash ROM (Read Only Memory) 25, a bridge 26 for relaying internal connection lines such as buses BUS which connect these units 21 to 25, and a power supply 27.

A BIOS (Basic Input/Output System) 250 is stored in the flash ROM 25. After the power supply 27 is turned on, the CPU 21 first accesses the flash ROM 25, executes the BIOS 250, and thereby recognizes the system configuration of the management server 3.

The HDD 24 stores at least an OS (Operating System) 241, an authentication program 242, an information processing device assignment program 243, an assignment condition classification reassignment decision program 244, a user information management table 245, an assignment condition storage table 246, a blade PC assignment state management table 247, a virtual PC server management table 248, a virtual PC assignment state management table 249, a utilization situation management table 250, and an assignment condition classification reassignment decision table 251.

The OS241 is a program used by the CPU 21 to generally control the units 22 to 27 in the management server 3 and execute the authentication program 242, the information processing device assignment program 243, and the assignment condition classification reassignment decision program 244 described later. The CPU 21 loads the OS 241 from the HDD 24 to the RAM 22 and executes the OS 241, in accordance with the BIOS 250. As a result, the CPU 21 generally controls the units 22 to 27 in the management server 3.

The authentication program 242 has a function of authenticating a user by using information processing device authentication information (a user ID and a password) supplied from a terminal 6 and authentication information (a user ID and a password) stored in the authentication information management table 245. The CPU 21 loads the authentication program 242 from the HDD 24 and executes the authentication program 242, in accordance with the OS 241.

The information processing device assignment program 243 has a function of making a decision whether information processing device to be assigned is a blade PC 1 or a virtual PC server 2 on the basis of the ratio of blade PCs 1 that are not yet assigned and condition information of assignment of information processing devices to users of terminals 6 stored in the HDD (storage unit) beforehand, in response to an information processing device assignment request supplied from a terminal 6, and a function of giving a notice of destination information of the assigned blade PC 1 or virtual PC server 2 to the terminal 6 of assignment request origin. The CPU 21 loads the information processing device assignment program 243 from the HDD24 and executes it, in accordance with the OS 241.

The assignment condition classification reassignment decision program 244 has a function of making a decision, every user, as to classification reassignment of information processing device assignment conditions on the basis of information processing device utilization time over a determinate period, CPU utilization factor and information in the assignment condition classification reassignment decision table 251 in the HDD 24. The CPU 21 loads the assignment condition classification reassignment decision program 244 from the HDD 24 and executes it, in accordance with the OS 241.

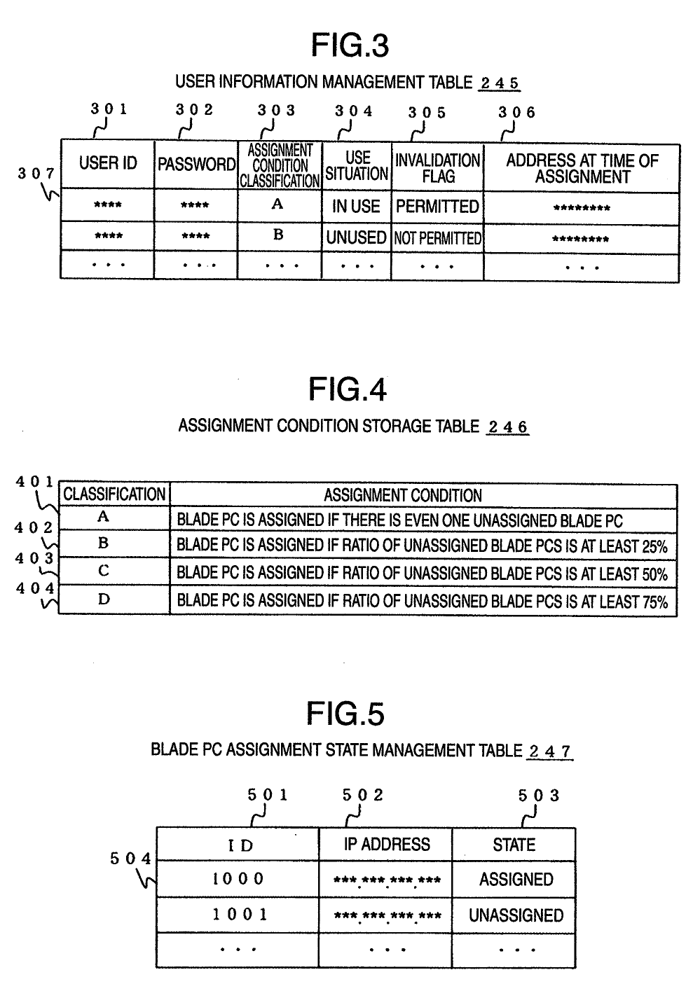

The user information management table 245 is a table for managing information relating to users who use information processing devices. FIG. 3 is a diagram showing a configuration example of the user information management table 245. As shown in FIG. 3, the user information management table 245 includes a plurality of records 307. Each record 307 includes a user ID registration field 301, a password registration field 302, a field 303 for registering information processing device assignment condition classification (A to D in the present embodiment) every user, a field 304 for registering situation (such as in use/unused) of information processing device use by the user, a field 305 for registering whether the user is permitted to use the information processing system (such as permitted/not permitted), and a field 306 for registering an address at the time of assignment of an information processing device to the terminal 6. The user ID 301 and the password 302 are authentication information for management server to be used by the management server 3 to authenticate the user of the terminal 6. If there is a special reason such as suspension from work or unfair utilization, “not permitted” is registered in the invalidation flag 305 by the manager. When an information processing device is assigned to the terminal 6 and the information processing device is a blade PC 1, an IP address of the blade PC 1 is registered in the address 306 at the time of information processing device assignment. When an information processing device is assigned to the terminal 6 and the information processing device is a virtual PC server 2, an IP address of the virtual PC server 2 and a virtual address of a virtual PC 20 are registered in the address 306 at the time of information processing device assignment. And each time a new address is assigned to the terminal 6, the information in the address 306 at the time of assignment is updated.

The assignment condition storage table 246 is a table for storing an assignment condition every assignment condition classification. FIG. 4 is a diagram showing a configuration example of the assignment condition storage table 246. According to an assignment condition 401 in the classification A, a blade PC is assigned if there is even one unassigned blade PC. According to an assignment condition 402 in the classification B, a blade PC is assigned if the ratio of unassigned blade PCs is at least 25%. According to an assignment condition 403 in the classification C, a blade PC is assigned if the ratio of unassigned blade PCs is at least 50%. According to an assignment condition 404 in the classification D, a blade PC is assigned if the ratio of unassigned blade PCs is at least 75%. In the present embodiment, the priority of the assignment condition classification is the highest in the classification A and the lowest in the classification D. By the way, the assignment condition classification and contents of the assignment condition for each classification are predetermined by the system manager, and registered in the assignment condition classification 303 in the user information management table 245 and the assignment condition storage table 246. At the time of initial registration, the assignment condition classification 303 is assigned beforehand according to the department or function of each user. For example, up to a chief is assigned the classification A, the section chief is assigned the classification B, and the head of a department is assigned classification C. And the assignment condition classification 303 for each user is reassigned by the assignment condition classification reassignment decision program 244 which will be described later.

The blade PC assignment state management table 247 is a table for managing the assigning state of the blade PCs 1. FIG. 5 is a diagram showing a configuration example of the blade PC assignment state management table 247. As shown in FIG. 5, the blade PC assignment state management table 247 includes a plurality of records 504. Each record 504 includes a field 501 for registering an ID to identify a blade PC 1, a field 502 for registering destination information (an IP address) of the blade PC 1, and a field 503 for registering an assignment state (assigned/unassigned) of the blade PC 1. The assignment state 503 of the blade PC 1 is set to “assigned” when the blade PC 1 is assigned, whereas it is set to “unassigned” when the assignment of the blade PC 1 is released.

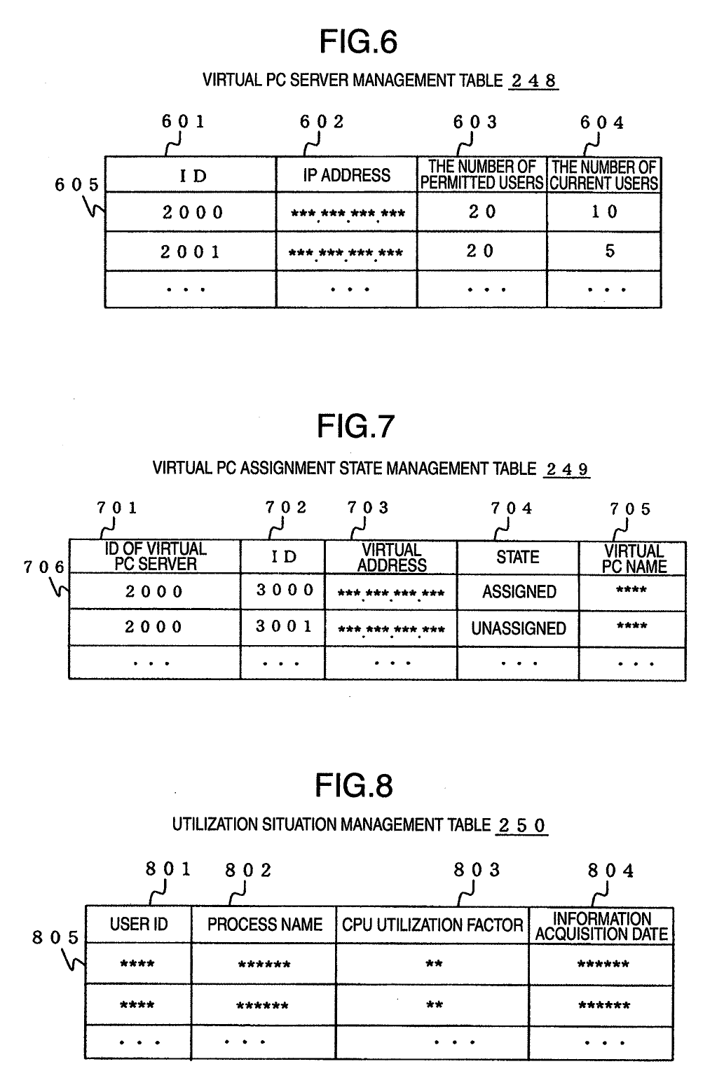

The virtual PC server management table 248 is a table for managing the number of permitted users for the virtual PC server 2 and the number of users who are using the virtual PC server 2. FIG. 6 is a diagram showing a configuration example of the virtual PC server management table 248. As shown in FIG. 6, the virtual PC server management table 248 includes a plurality of records 605. Each record 605 includes a field 601 for registering an ID to identify a virtual PC server 2, a field 602 for registering destination information (an IP address) of the virtual PC server, a field 603 for registering the number of permitted users for the virtual PC server 2, and a field 604 for registering the number of users who are using the virtual PC server 2.

The virtual PC assignment state management table 249 is a table for managing assignment states of the virtual PCs 20 in the virtual PC server 2. FIG. 7 is a diagram showing a configuration example of the virtual PC assignment state management table 249. As shown in FIG. 7, the virtual PC assignment state management table 249 includes a plurality of records 706. Each record 706 includes a field 701 for registering an ID to identify a virtual PC server 2, a field 702 for registering an ID to identify a virtual PC 20, a field 703 for registering a virtual address assigned to the virtual PC 20, a field 704 for registering a virtual PC assignment state (assigned/unassigned), and a field 705 for registering a name of the virtual PC. The virtual PC 20 assignment state 704 is set to “assigned” when the virtual PC 20 is assigned and set to “unassigned” when the assignment of the virtual PC 20 is released.

The utilization situation management table 250 is a table for managing a CPU utilization factor every user. FIG. 8 is a diagram showing a configuration example of the utilization situation management table 250. The utilization situation management table 250 includes a plurality of records 805. Each record 805 includes a field 801 for registering a user ID, a field 802 for registering a process name, a field 803 for registering a CPU utilization factor, and a field 804 for registering date when information such as the CPU utilization factor is acquired. By the way, the CPU utilization factor is registered in the CPU utilization factor 803 in the utilization situation management table 250 at definite periods.

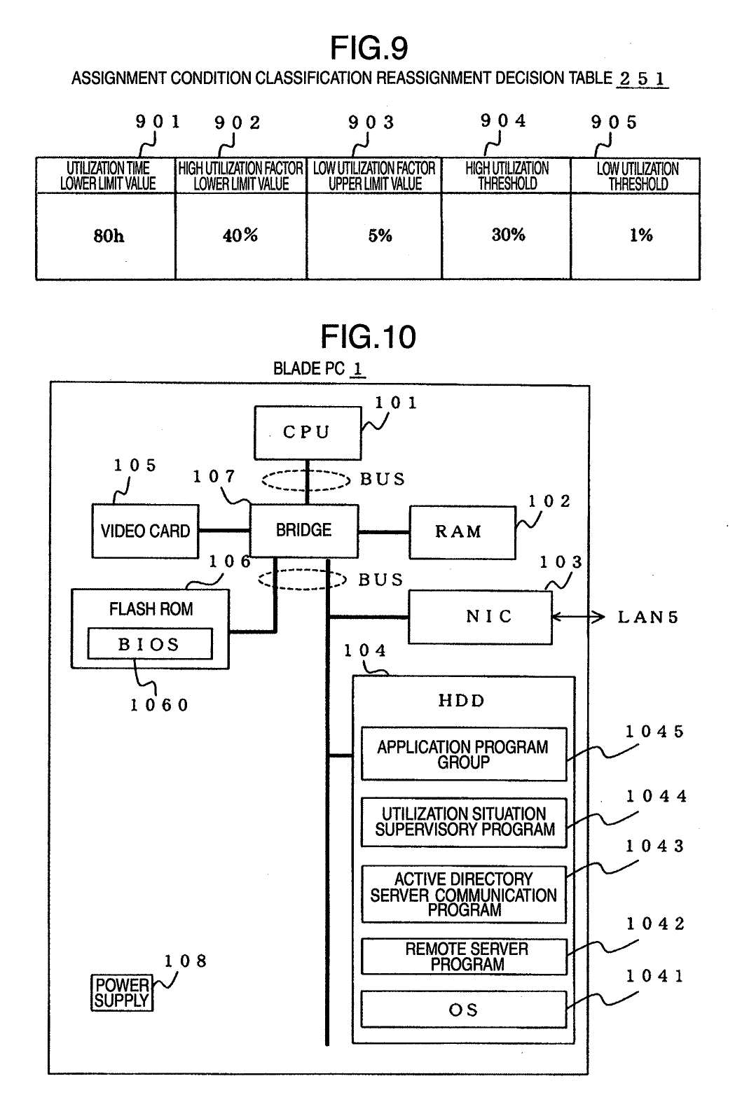

The assignment condition classification reassignment decision table 251 is a table for making a decision as to reassignment of information processing device assignment condition. FIG. 9 is a diagram showing a configuration example of the assignment condition classification reassignment decision table 251. As shown in FIG. 9, the assignment condition classification reassignment decision table 251 includes a field 901 for registering a lower limit value of information processing device utilization time, a field 902 for registering a high utilization factor lower limit value of the CPU utilization factor, a field 903 for registering a low utilization factor upper limit value of the CPU utilization factor, a field 904 for registering a high utilization threshold of the CPU utilization factor, and a field 905 for registering a low utilization threshold of the CPU utilization factor. Here, the CPU utilization factor that is at least the high utilization factor lower limit value 902 is regarded as high utilization. The CPU utilization factor that is at most the low utilization factor upper limit value 903 is regarded as low utilization.

Referring back to FIG. 1, description will be continued.

A blade PC 1 provides terminal service to a terminal 6. In other words, the blade PC 1 receives and processes input information (manipulation contents of the keyboard and mouse) sent from the terminal 6, and transmits information that indicates a result of the processing (a desktop screen of the display) to the terminal 6.

FIG. 10 is a diagram showing a schematic configuration example of the blade PC 1.

As shown in FIG. 10, the blade PC 1 includes a CPU 101, a RAM 102 functioning as a work area of the CPU 101, a NIC 103 for connection to the LAN 5, an HDD 104, a video card 105 for generating desktop video information, a flash ROM 106, a bridge 107 for relaying internal connection lines such as buses BUS which connect these units 102 to 106, and a power supply 108.

A BIOS 1060 is stored in the flash ROM 106. After the power supply 108 is turned on, the CPU 101 first accesses the flash ROM 106, executes the BIOS 1060, and thereby recognizes the system configuration of the blade PC 1.

The HDD 104 stores at least an OS 1041, a remote server program 1042, an active directory server communication program 1043, a utilization situation supervisory program 1044, and an application program group 1045.

The OS1041 is a program used by the CPU 101 to generally control the units 102 to 108 in the blade PC 1 and execute the programs 1042 to 1045 which will be described later. The CPU 101 loads the OS 1041 from the HDD 104 to the RAM 102 and executes the OS 1041, in accordance with the BIOS 1060. As a result, the CPU 101 generally controls the units 102 to 108 in the blade PC 1.

The remote server program 1042 is a program for providing the terminal 6 with terminal service, i.e., for exercising remote control over the desktop of the blade PC 1 from the terminal 6. The CPU 101 loads the remote server program 1042 from the HDD 104 to the RAM 102 and executes the remote server program 1042, in accordance with the OS 1041. As a result, the CPU 101 receives and processes input information (manipulation contents of the keyboard and mouse) sent from the terminal 6 via the LAN 5 and the NIC 103, and transmits video information that indicates a result of the processing (a desktop screen of the display) to the terminal 6 via the NIC 103 and the LAN 5.

The active directory server communication program 1043 is a program for conducting communication with the active directory server 4. The CPU 101 loads the active directory server communication program 1043 from the HDD 104 to the RAM 102 and executes the program, in accordance with the OS 1041.

The utilization situation supervisory program 1044 is a program for supervising utilization time of the blade PC 1 and the CPU utilization factor of every process. As the utilization situation supervisory program 1044, for example, the performance monitor program mounted on the Windows (trade mark) as a standard program is used. The CPU 101 loads the utilization situation supervisory program 1044 from the HDD 104 to the RAM 102 and executes the program, in accordance with the OS 1041.

The application program group 1045 includes programs of general purpose web browser, word processor and spread sheet. The CPU 101 loads a desired application program 1045 from the HDD 104 to the RAM 102 and executes the desired application program, in accordance with the OS 1041 and in response to an order accepted from the terminal 6 via the remote server program 1042. And the CPU 101 causes the video card 105 to generate video information of the desktop screen with a result of the execution reflected and transmits the video information to the terminal 6 via the remote server program 1042.

Referring back to FIG. 1, description will be continued.

The virtual PC server 2 provides a PC environment spuriously by using software on the virtual PC server 2. The virtual PC server 2 provides the terminal 6 with terminal service. In other words, the virtual PC server 2 receives and processes input information (manipulation contents of the keyboard and mouse) sent from the terminal 6, and transmits information that indicates a result of the processing (a desktop screen of the display) to the terminal 6.

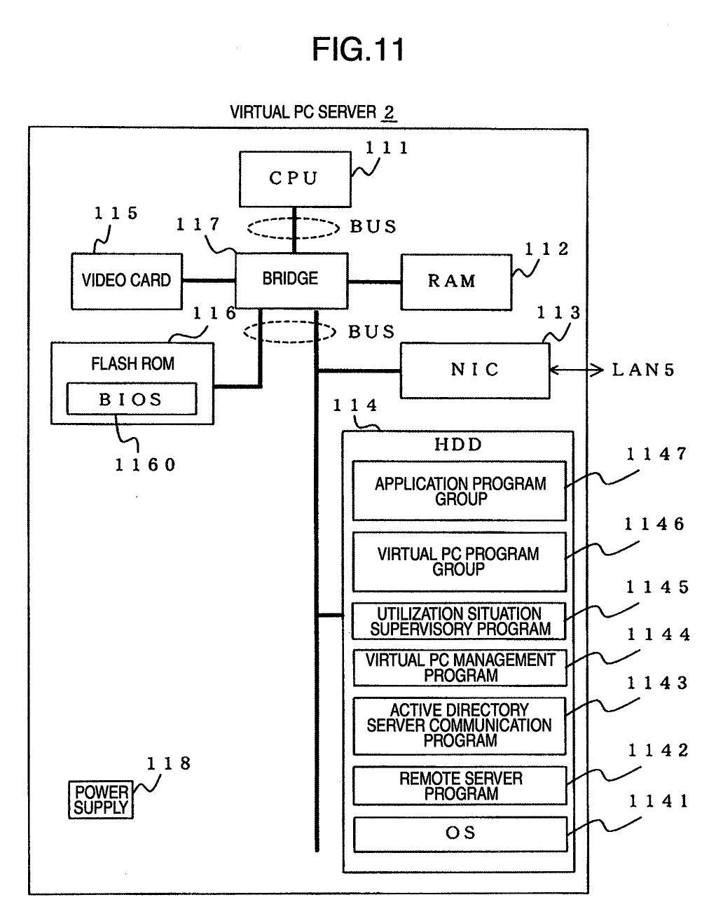

FIG. 11 is a diagram showing a schematic configuration example of the virtual PC server 2.

As shown in FIG. 11, the virtual PC server 2 includes a CPU 111, a RAM 112 functioning as a work area of the CPU 111, a NIC 113 for connection to the LAN 5, an HDD 114, a video card 115 for generating desktop video information, a flash ROM 116, a bridge 117 for relaying internal connection lines such as buses BUS which connect these units 112 to 116, and a power supply 118.

A BIOS 1160 is stored in the flash ROM 116. After the power supply 118 is turned on, the CPU 111 first accesses the flash ROM 116, executes the BIOS 1160, and thereby recognizes the system configuration of the virtual PC server 2.

The HDD 114 stores at least an OS 1141, a remote server program 1142, an active directory server communication program 1143, a virtual PC management program 1144, a utilization situation supervisory program 1145, a virtual PC program group 1146, and an application program group 1147.

The OS 1141 is a program used by the CPU 111 to generally control the units 112 to 118 in the virtual PC server 2 and execute the programs 1142 to 1147 which will be described later. The CPU 111 loads the OS 1141 from the HDD 114 to the RAM 112 and executes the OS 1141, in accordance with the BIOS 1160. As a result, the CPU 111 generally controls the units 112 to 118 in the virtual PC server 2.

The remote server program 1142 is a program for providing the terminal 6 with terminal service, i.e., for exercising remote control over the desktop of the virtual PC server 2 from the terminal 6. The CPU 111 loads the remote server program 1142 from the HDD 114 to the RAM 112 and executes the remote server program 1142, in accordance with the OS 1141. As a result, the CPU 111 receives and processes input information (manipulation contents of the keyboard and mouse) sent from the terminal 6 via the LAN 5 and the NIC 113, and transmits video information that indicates a result of the processing (a desktop screen of the display) to the terminal 6 via the NIC 113 and the LAN 5.

The active directory server communication program 1143 is a program for conducting communication with the active directory server 4. The CPU 111 loads the active directory server communication program 1143 from the HDD 114 to the RAM 112 and executes the program, in accordance with the OS 1141.

The virtual PC management program 1144 is a program for starting a virtual PC program group generated spuriously by software and managing an operation state of the virtual PC program group. The CPU 111 loads the virtual PC management program 1144 from the HDD 114 to the RAM 112 and executes the program, in accordance with the OS 1141.

The utilization situation supervisory program 1145 is a program for supervising utilization time of the virtual PC server 2 and the CPU utilization factor of every process. As the utilization situation supervisory program 1145, for example, the performance monitor program mounted on the Windows (trade mark) as a standard program is used. The CPU 111 loads the utilization situation supervisory program 1145 from the HDD 114 to the RAM 112 and executes the program, in accordance with the OS 1141.

The virtual PC program group 1146 is a program that becomes an entity of the virtual PC. The CPU 111 loads a virtual PC program 1146 to be executed from the HDD 114 to the RAM 112 and executes the program, in accordance with the OS 1141.

The application program group 1147 includes programs of general purpose web browser, word processor and spread sheet. The CPU 111 loads a desired application program 1147 from the HDD 114 to the RAM 112 and executes the desired application program, in accordance with the OS 1141 and in response to an order accepted from the terminal 6 via the remote server program 1142. And the CPU 111 causes the video card 115 to generate video information of the desktop screen with a result of the execution reflected and transmits the video information to the terminal 6 via the remote server program 1142.

Referring back to FIG. 1, description will be continued.

The active directory server 4 has a function of transmitting a script for starting the utilization situation supervisory programs (1044, 1145) stored in the HDD 104 in the blade PC 1 and the HDD 114 in the virtual PC server 2 to the blade PC 1 and the virtual PC server 2, a function of transmitting profile information such as setting of network drive and arrangement of information processing devices to the blade PC 1 and the virtual PC server 2, a function of receiving utilization situation data from the blade PC 1 and the virtual PC server 2 and storing the utilization situation data in the HDDs, and a function of transmitting the utilization situation data stored in the HDD to the management server 3 upon receiving an active directory server utilization end request from the blade PC 1 or the virtual PC server 2 by desktop manipulation at the terminal 6.

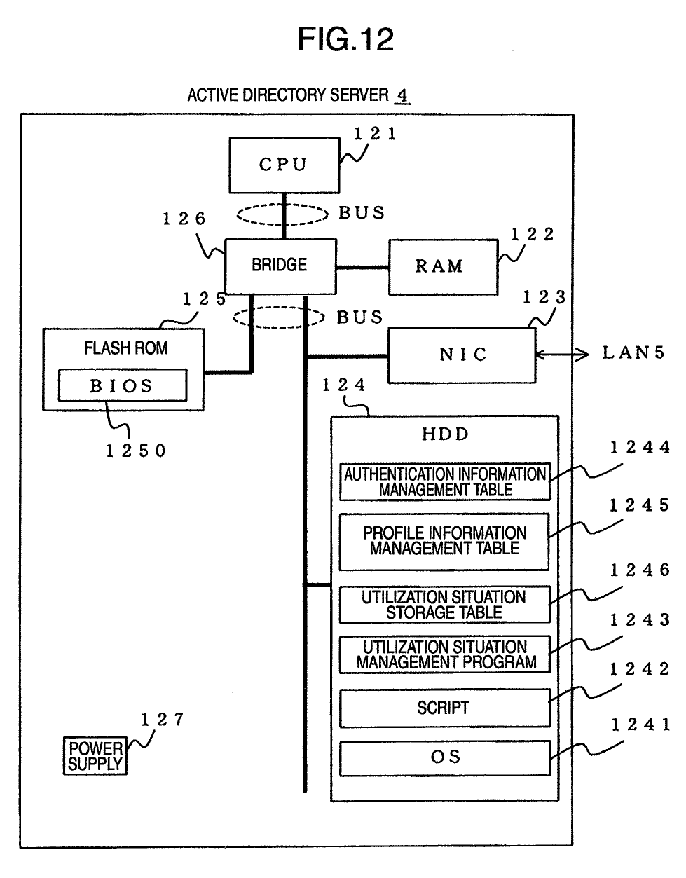

FIG. 12 is a diagram showing a schematic configuration example of the active directory server 4.

As shown in FIG. 12, the active directory server 4 includes a CPU 121, a RAM 122 functioning as a work area of the CPU 121, a NIC 123 for connection to the LAN 5, an HDD 124, a flash ROM 125, a bridge 126 for relaying internal connection lines such as buses BUS which connect these units 122 to 125, and a power supply 127.

A BIOS 1250 is stored in the flash ROM 125. After the power supply 127 is turned on, the CPU 121 first accesses the flash ROM 125, executes the BIOS 1250, and thereby recognizes the system configuration of the active directory server 4.

The HDD 124 stores at least an OS 1241, a script 1242, a utilization situation management program 1243, an authentication information management table 1244, a profile information management table 1245, and a utilization situation storage table 1246.

The OS1241 is a program used by the CPU 121 to generally control the units 122 to 127 in the active directory server 4 and execute the utilization situation management program 1243. The CPU 121 loads the OS 1241 from the HDD 124 to the RAM 122 and executes the OS 1241, in accordance with the BIOS 1250. As a result, the CPU 121 generally controls the units 122 to 127 in the active directory server 4.

The script 1242 is a program for starting the utilization situation supervisory program in the blade PC 1 and the virtual PC server 2. Upon receiving a utilization start request of the active directory server 4 from the blade PC 1 or the virtual PC server 2, the CPU 121 transmits the script 1242 to the blade PC 1 or the virtual PC server 2 of the request origin.

The utilization situation management program 1243 has a function of storing utilization situation data received from the blade PC 1 or the virtual PC server 2 in the utilization situation storage table 1246, and reading out utilization situation data from the utilization situation storage table 1246 and transmitting the utilization situation data to the management server 3 upon receiving an active directory server utilization end request from the blade PC 1 or the virtual PC server 2. The CPU 121 loads the utilization situation management program 1243 from the HDD 124 to the RAM 122 and executes the program, in accordance with the OS 1241.

The authentication information management table 1244 stores a plurality of user IDs and passwords.

The profile information management table 1245 stores profile information such as setting of network drive and arrangement of information processing devices. Owing to this profile information, it becomes possible to use a file placed on an information processing device by using the same path specification no matter which information processing device is used by the terminal 6.

Referring back to FIG. 1, description will be continued.

The terminal 6 receives terminal service from the blade PC 1 or the virtual PC server 2. In other words, the terminal 6 transmits input information (manipulation contents of the keyboard and mouse) which is input to the terminal 6 to the blade PC 1 or the virtual PC server 2, receives video information (a desktop screen of the display) from the blade PC 1 or the virtual PC server 2, and displays the video information on the display of the terminal 6.

By the way, the terminal 6 is a PC of the so-called HDD-less type in order to reduce the possibility of information leak due to theft or the like.

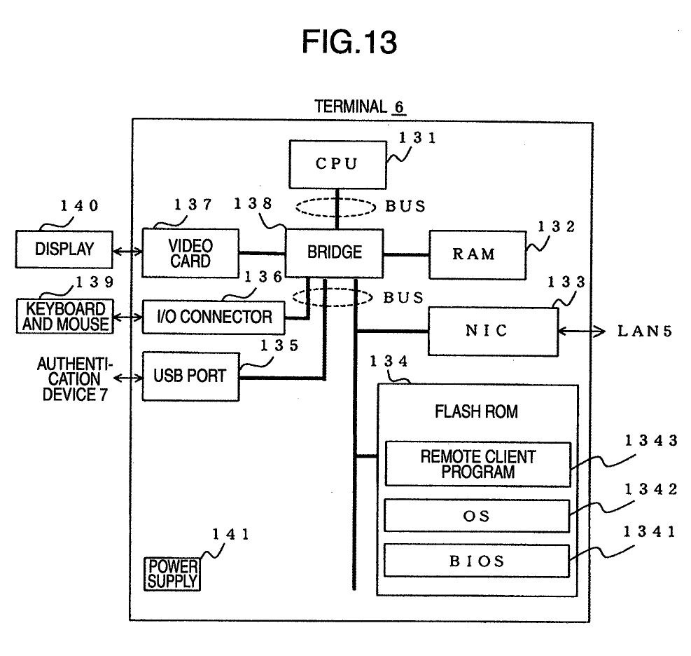

FIG. 13 is a diagram showing a schematic configuration example of the terminal 6.

As shown in FIG. 13, the terminal 6 includes a CPU 131, a RAM 132 functioning as a work area of the CPU 131, a NIC 133 for connection to the LAN 5, a flash ROM 134, a USB port 135 for connection to an authentication device 7, an I/O connector 136 for connection to a keyboard and mouse 139, a video card 137 for connection to a display 140, a bridge 138 for relaying internal connection lines such as buses BUS which connect these units 131 to 137, and a power supply 141.

At least a BIOS 1341, an OS 1342, and a remote client program 1343 are stored in the flash ROM 134.

After the power supply 141 is turned on, the CPU 131 first accesses the flash ROM 134, executes the BIOS 1341, and thereby recognizes the system configuration of the terminal 6.

The OS1342 is a program used by the CPU 131 to generally control the units 132 to 137 and 141 in the terminal 6 and execute the remote client program 1343 which will be described later. The CPU 131 loads the OS 1342 from the flash ROM 134 to the RAM 132 and executes the OS 1342, in accordance with the BIOS 1341. As a result, the CPU 131 generally controls the units 132 to 138 in the terminal 6. By the way, a comparatively small OS that can be stored in the flash ROM 134, such as an embedded OS is utilized as the OS 1342 in the present embodiment.

The remote client program 1343 is a program for receiving terminal service, i.e., a program to be used by the terminal 6 to access the desktop of the blade PC 1 or the virtual PC server 2 from a remote place. The CPU 131 loads the remote client program 1343 from the flash ROM 134 to the RAM 132 and executes the remote client program 1343, in accordance with the OS 1342. As a result, the CPU 131 transmits input information (manipulation contents of the keyboard and mouse) which is input from the keyboard and mouse 139 and received via the I/O connector 136 to the blade PC 1 or the virtual PC server 2 via the NIC 133 and the LAN 5, and outputs video information (a desktop screen of the display) sent from the blade PC 1 or the virtual PC server 2 via the LAN 5 and the NIC 133 to the display 140 connected to the video card 137.

Referring back to FIG. 1, description will be continued.

The authentication device 7 authenticates authentication information for terminal (a user ID and a password) received from the terminal 6, and gives a notice of a result of the authentication to the terminal 6. If the result of the authentication indicates establishment of authentication, the authentication device 7 gives a notice of an address of the management server 3 and authentication information (a user ID and a password) for management server registered in the authentication device 7 together with the result of the authentication to the terminal 6.

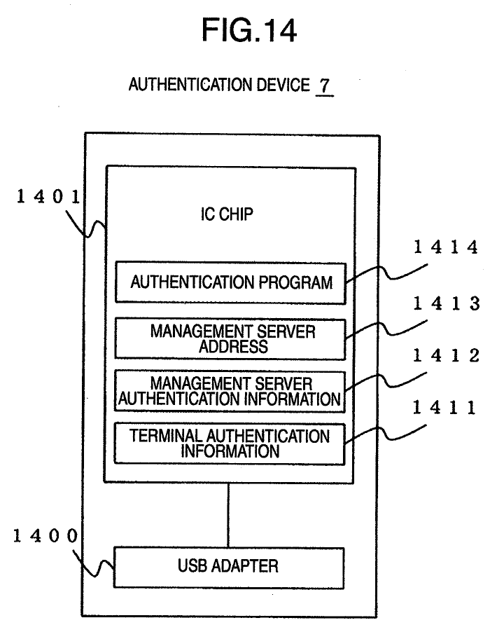

FIG. 14 is a schematic diagram of the authentication device 7. As shown in FIG. 14, the authentication device 7 includes a USB adapter 1400 for connection to the USB port 135 in the terminal 6 and an IC chip 1401.

Terminal authentication information (a user ID and a password) 1411, management server authentication information (a user ID and a password) 1412, an address 1413 of the management server 3, and an authentication program 1414 are stored in the IC chip 1401. By the way, it is also possible to configure the authentication device 7 so that a flash memory may be attached to the authentication device 7 externally and store a part of data stored in the IC chip 1401 in the flash memory.

The authentication program 1414 is a program for conducting user authentication by using the user ID and the password input to the terminal 6 that is connected to the own authentication device 7 and terminal authentication information (a user ID and a password) 1411.

The USB adapter 1400 in the authentication device 7 is connected to the USB port 135 in the terminal 6. As a result, power is supplied from the terminal 6 to the authentication device 7, and then, the IC chip 1401 executes the authentication program 1414.

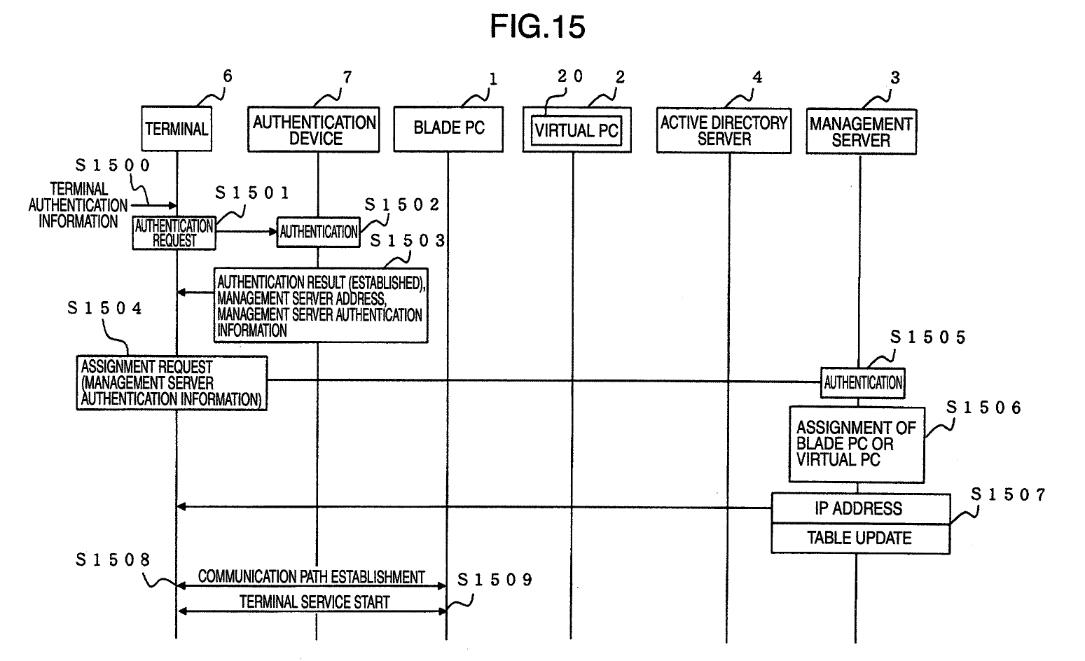

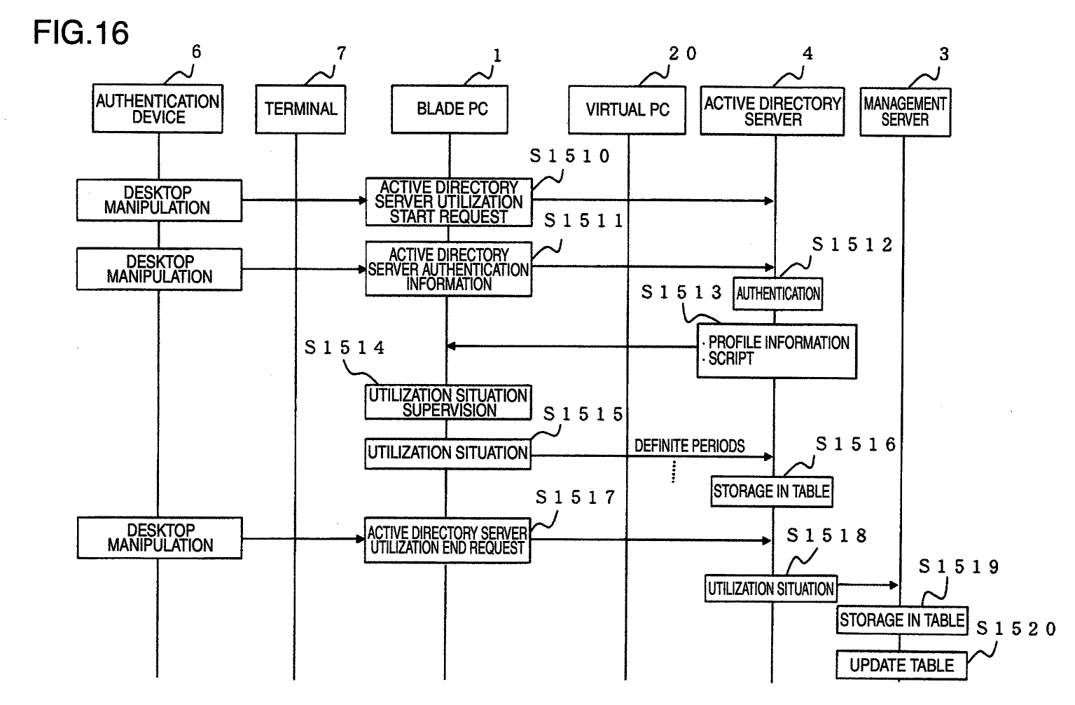

FIGS. 15 and 16 are diagrams showing operation of the whole information processing system in the present embodiment. By the way, each processing shown in FIGS. 15 and 16 is executed by the CPU in accordance with programs. Each processing will now be described simply supposing the CPU is the entity of execution, in order to simplify the description. Description will be conducted by taking a blade PC 1 as an example of the assigned information processing device.

First, the CPU 131 in the terminal 6 causes the display 140 connected to the video card 137 to display an input form of the terminal authentication information (user ID and password). And the CPU 131 receives the terminal authentication information input from the keyboard and mouse 139 via the I/O connector 136 (step 1500). The CPU 131 transmits the terminal authentication information to the authentication device 7 connected to the USB port 135, and requests user authentication (step 1501).

The authentication device 7 conducts user authentication by using the terminal authentication information received from the terminal 6 and the terminal authentication information 1411 (FIG. 14) previously registered in the authentication device 7 (step 1502). If the user authentication is established, the authentication device 7 transmits a result of the authentication and the management server authentication information (user ID and password) and the IP address 1413 of the management server 3 (FIG. 14) previously registered in the authentication device 7 to the terminal 6 (step 1503). Subsequently, the CPU 131 in the terminal 6 transmits an information processing device assignment request to the management server 3 (step 1504). At the time of this assignment request, the CPU 131 in the terminal 6 transmits the management server authentication information (user ID and password) as well to the management server 3. By the way, if the user authentication is not established at the step 1502, the authentication device 7 gives a notice of its result to the terminal 6.

The CPU 21 in the management server 3 conducts authentication by using the received management server authentication information (user ID and password) and authentication information (user ID and password) previously registered in the user information management table 245 in the management server 3 (step 1505). After the establishment of the authentication, the CPU 21 determines a blade PC 1 or a virtual PC server 2 to be assigned to a terminal 6 of the assignment request origin, on the basis of information of the user information management table 245, the assignment condition storage table 246, the blade PC assignment state management table 247, and the virtual PC server management table 248 (step 1506). Details of assignment processing of the blade PC 1 or the virtual PC server 2 will be described later.

When, for example, a blade PC 1 is to be assigned, the CPU 21 refers to the IP address 502 in the blade PC assignment state management table 247 (FIG. 5) and gives a notice of the IP address of the assigned blade PC 1 to the terminal 6 of the assignment request origin. Furthermore, the CPU 21 changes information of the state 503 in the blade PC assignment state management table 247 corresponding to the IP address from “unassigned” to “assigned” (step 1507).

A communication path is established between the terminal 6 and a blade PC 1 having the IP address of the blade PC 1 received from the management server 3, by using predetermined communication programs (not illustrated) included in the terminal 6 and the blade PC 1 (step 1508). The blade PC 1 starts terminal service to the terminal 6 (step 1509).

Subsequently, in response to desktop manipulation utilizing the terminal service, the CPU 101 in the blade PC 1 transmits a utilization start request for the active directory server 4 to the active directory server 4 (step 1510). Furthermore, in response to desktop manipulation utilizing the terminal service, the CPU 101 transmits active directory server authentication information (the user ID and password) to the active directory server 4 (step 1511).

The CPU 121 in the active directory server 4 conducts authentication by using the active directory server authentication information (user ID and password) supplied from the blade PC 1 and authentication information (user ID and password) stored in the authentication information management table 1244 in the HDD 124 (step 1512). After the establishment of the authentication, the CPU 121 in the active directory server 4 transmits the profile information stored in the profile information management table 1245 in the HDD 124 and the script 1242 to the blade PC 1 (step 1513). If the authentication is not established at the step 1512, the CPU 121 gives a notice of the result to the terminal 6.

Upon receiving the script 1242, the CPU 101 in the blade PC 1 supervises the utilization situation of the own blade PC 1 such as the CPU utilization factor at definite periods (step 1514) and transmits the utilization situation data to the active directory server 4 at definite periods (step 1515).

The CPU 121 in the active directory server 4 stores the utilization situation data received from the blade PC 1 in the utilization situation storage table 1246 (step 1516).

Subsequently, in response to desktop manipulation utilizing the terminal service, the CPU 101 in the blade PC 1 transmits an active directory server utilization end request to the active directory server 4 (step 1517).

Upon receiving the active directory server utilization end request from the blade PC 1, the CPU 121 in the active directory server 4 transmits utilization situation data stored in the utilization situation storage table 1246 to the management server 3 (step 1518).

Upon receiving the utilization situation data from the active directory server 4, the CPU 21 in the management server 3 stores the utilization situation data in the utilization situation management table 250 (step 1519). Subsequently, the CPU 21 changes information of the state 503 in the blade PC assignment state management table 247 corresponding to the IP address of the blade PC 1 assigned at the step 1606, from “assigned” to “unassigned” (step 1520).

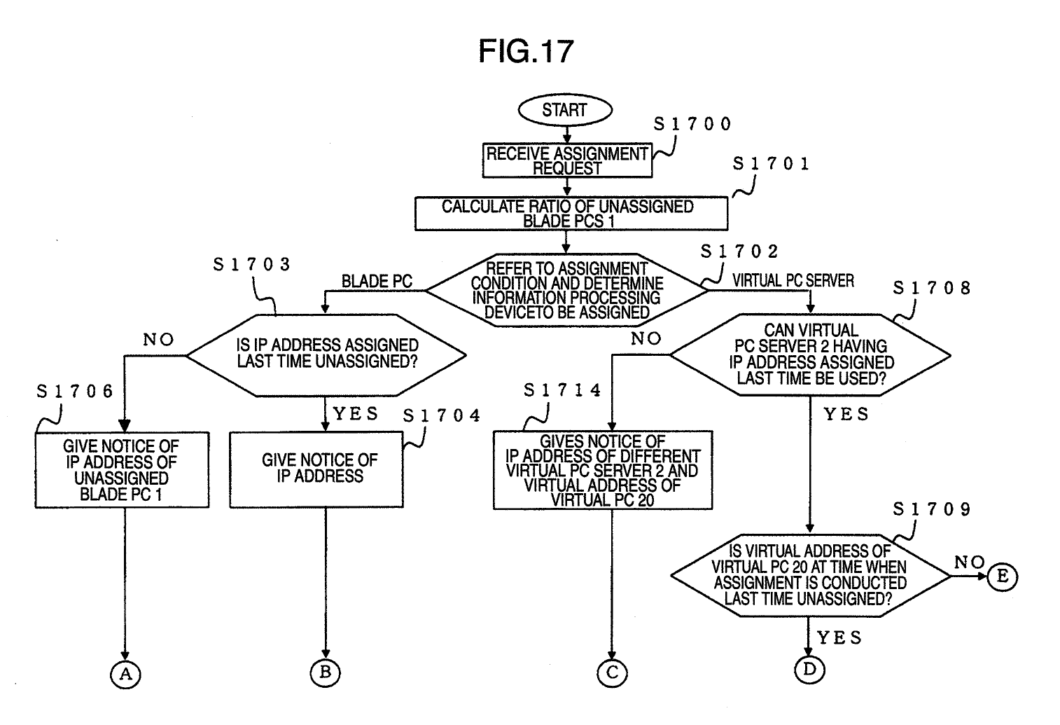

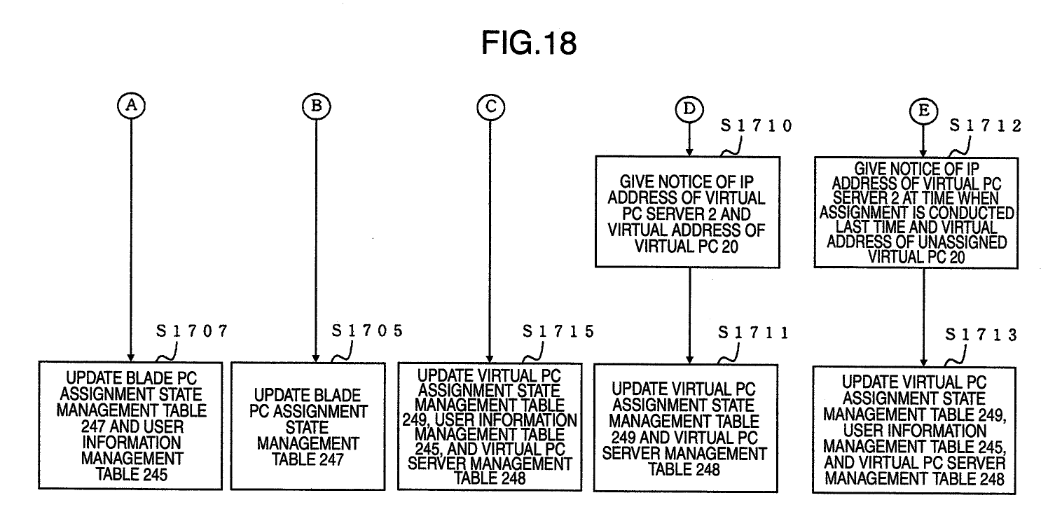

FIGS. 17 and 18 are flow charts showing details of assignment processing of a blade PC 1 or a virtual PC server 2 conducted in the management server 3.

Upon receiving an information processing device assignment request from a terminal 6 (step 1700), the CPU 21 in the management server 3 first refers to the state 503 in the blade PC assignment state management table 247 (FIG. 5) and calculates the ratio of unassigned blade PCs 1 (step 1701). Subsequently, the CPU 121 discriminates an assignment condition classification assigned to a user of a terminal 6 of the assignment request origin, on the basis of a user ID and a password contained in the information processing device assignment request and the user ID 301 and the password 302 stored in the user information management table 245 (FIG. 3). The CPU 21 refers to an assignment condition in the condition storage table 246 (FIG. 4) on the basis of the discriminated assignment condition classification, and determines an information processing device to be assigned (step 1702). For example, it is supposed that the total number of blade PCs 1 is 100 whereas the number of unassigned blade PCs 1 is 60 and the assignment condition classification of the user is “B.” In this case, the CPU 21 calculates the ratio of unassigned blade PCs 1 and obtains 40%. The CPU 21 refers to the user information management table 245, and decides to assign a blade PC 1 to the terminal 6 of the assignment request origin on the basis of the assignment condition 402 for the classification B and the calculated ratio (40%) of the unassigned blade PCs 1. If the CPU 21 decides to assign a blade PC 1 to the terminal 6 of the assignment request origin at the step 1702, then the CPU 21 refers to the address 306 at the time of assignment in the user information management table 245 (FIG. 3) and the state 503 in the blade PC assignment state management table 247 (FIG. 5) and makes a decision whether an IP address assigned last time is unassigned (step 1703). If it is found as a result of this decision that the IP address assigned last time is unassigned, the CPU 21 gives a notice of the IP address to the terminal 6 of the assignment request origin (step 1704). And the CPU 21 changes the state 503 of the IP address in the blade PC assignment state management table 247 from “unassigned” to “assigned” (step 1705).

If it is found at the step 1703 that the IP address assigned last time is already assigned to a different user, the CPU 21 gives a notice of an IP address of an unassigned blade PC 1 to the terminal 6 of the assignment request origin (step 1706). And the CPU 21 changes the state 503 of this IP address in the blade PC assignment state management table 247 from “unassigned” to “assigned.” Furthermore, the CPU 21 rewrites information in the address 306 at the time of assignment in the user information management table 245 to this IP address (step 1707).

If the CPU 21 decides to assign a virtual PC server 2 to the terminal 6 of the assignment request origin at the step 1702, then the CPU 21 refers to the address 306 at the time of assignment in the user information management table 245 (FIG. 3) and the virtual PC server management table 248 (FIG. 6) and makes a decision whether a virtual PC server 2 having an IP address assigned last time can be used (step 1708). For example, if the number of current users 604 is less than the number 603 of permitted users for a virtual PC server 2 having an IP address assigned last time, the CPU 21 judges that the virtual PC server 2 can be used. If the CPU 21 judges at the step 1708 that the virtual PC server 2 having an IP address assigned last time can be used, then the CPU 21 refers to the address 306 at the time of assignment in the user information management table 245 (FIG. 3) and the virtual PC assignment state management table 249 (FIG. 7) and makes a decision whether a virtual address of the virtual PC 20 at the time when assignment is conducted last time is unassigned (step 1709). If it is found as a result of this decision that the virtual address of the virtual PC 20 at the time when assignment is conducted last time is unassigned, the CPU 21 gives a notice of the IP address of the virtual PC server 2 and the virtual address of the virtual PC 20 at the time when assignment is conducted last time to the terminal 6 of the assignment request origin (step 1710). And the CPU 21 changes the state 704 of this virtual address in the virtual PC assignment state management table 249 from “unassigned” to “assigned.” Furthermore, the CPU 21 updates (increases by 1) the information of the number of current users 604 in the virtual PC server management table 248 (step 1711).

If it is found at the step 1709 that the virtual address of the virtual PC 20 at the time when assignment is conducted last time is assigned to a different user, the CPU 21 gives a notice of the IP address of the virtual PC server 2 at the time when assignment is conducted last time and a virtual address of an unassigned virtual PC 20 to the terminal 6 of the assignment request origin (step 1712). And the CPU 21 changes the state 704 of this virtual address in the virtual PC assignment state management table 249 from “unassigned” to “assigned.” Furthermore, the CPU 21 rewrites information in the address 306 at the time of assignment in the user information management table 245 to the assigned IP address and virtual address. In addition, the CPU 21 updates (increases by 1) the information of the number of current users 604 in the virtual PC server management table 248 (step 1713).

If the CPU 21 judges at the step 1708 that the virtual PC server 2 having the IP address assigned last time cannot be used, then the CPU 21 refers to the virtual PC server management table 248 and reads out, for example, an IP address 602 of a virtual PC server 2 that is the smallest in the number of current users 604. In addition, the CPU 21 refers to the virtual PC assignment state management table 249, reads out a virtual address 703 of an unassigned virtual PC 20 in the virtual PC server 2, and gives a notice of addresses of them to the terminal 6 of the assignment request origin (step 1714). The CPU 21 changes the state 704 of this virtual address in the virtual PC assignment state management table 249 from “unassigned” to “assigned.” Furthermore, the CPU 21 rewrites information in the address 306 at the time of assignment in the user information management table 245 to the assigned IP address and virtual address. In addition, the CPU 21 updates (increases by 1) the information of the number of current users 604 in the virtual PC server management table 248 (step 1715).

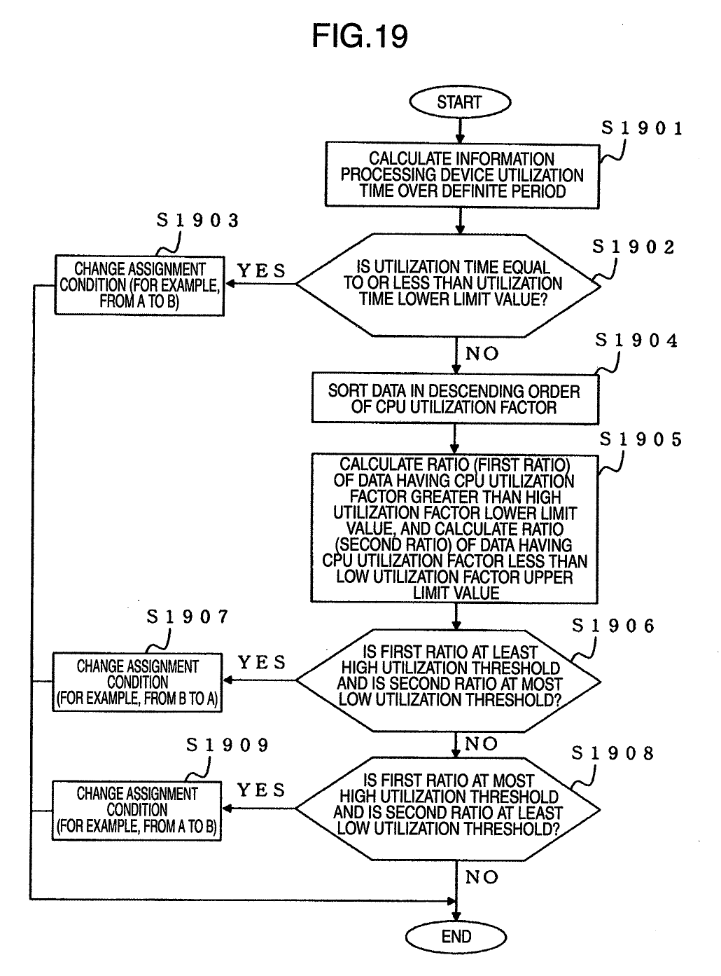

FIG. 19 is a flow chart showing processing of an assignment condition classification reassignment decision.

First, the CPU 21 in the management server 3 refers to the utilization situation management table 250 and calculates information processing device utilization time over a definite period (step 1901). Since utilization situation data are recorded in the utilization situation management table 250 at definite time periods, the CPU 21 calculates information processing device utilization time over a definite period by counting the number of data. For example, if utilization situation data are recorded in the utilization situation management table 250 at intervals of 5 seconds and there are 55,000 utilization situation data of the user, then the information processing device utilization time is 27,500 seconds (approximately 76 hours). Subsequently, the CPU 21 makes a decision whether the utilization time is equal to or less than the utilization time lower limit value in the assignment condition classification reassignment decision table 251 (step 1902). If the utilization time is equal to or less than the utilization time lower limit value, then the CPU 21 changes the assignment condition classification, for example “from A to B” (step 1903). It is supposed that information processing device utilization time of a certain user is 76 hours as described above. If in this case half (80 hours) of the standard utilization time is determined to be the utilization time lower limit value, then the utilization time (76 hours) is less than the utilization time lower limit value (80 hours). Therefore, the CPU 21 judges that the user does not need information processing devices so much and changes the assignment condition classification, for example “from A to B.” If it is found as a result of the decision at the step 1902 that the utilization time is not the utilization time lower limit value or less, then the CPU 21 sorts data in the descending order of the CPU utilization factor (step 1904). Subsequently, the CPU 21 calculates a ratio (referred to as first ratio) of data having a CPU utilization factor greater than the high utilization factor lower limit value 902 in the assignment condition classification reassignment decision table 251. In addition, the CPU 21 calculates a ratio (referred to as second ratio) of data having a CPU utilization factor less than the low utilization factor upper limit value 903 in the assignment condition classification reassignment decision table 251 (step 1905). For example, it is supposed that the high utilization factor lower limit value 902 is 40% and the low utilization factor upper limit value 903 is 5% as shown in FIG. 9. It is supposed that among 55,000 utilization situation data sorted in the descending order of CPU utilization factor the CPU utilization factor is 41% in the 39,501st data, 40% in the 39,500th data, 5% in the 1,101st data, and 4% in the 1,100th data. In this case, a minimum CPU utilization factor greater than the high utilization lower limit value (40%) is obtained in the 39,501st data, and a maximum CPU utilization factor less than the low utilization factor upper limit value (5%) is obtained in the 1,100th data. The CPU 21 calculates the ratio of the number of data that are higher in CPU utilization factor than the high utilization factor lower limit value 902, and obtains ((55,000-39,501)÷55,000)×100=28.2%. Furthermore, The CPU 21 calculates the ratio of the number of data that are lower in CPU utilization factor than the low utilization factor upper limit value 903, and obtains (1,100÷55,000)×100=2.0%.

Subsequently, the CPU 21 makes a decision whether the first ratio is at least the high utilization threshold 904 in the assignment condition classification reassignment decision table 251 and the second ratio is at most the low utilization threshold 905 in the assignment condition classification reassignment decision table 251 (step 1906). If the first ratio is at least the high utilization threshold 904 in the assignment condition classification reassignment decision table 251 and the second ratio is at most the low utilization threshold 905 in the assignment condition classification reassignment decision table 251, then the CPU 21 judges that the user uses information processing devices very frequently and changes the assignment condition classification, for example, from “B to A” (step 1907). Unless the first ratio is at least the high utilization threshold 904 in the assignment condition classification reassignment decision table 251 and the second ratio is at most the low utilization threshold 905 in the assignment condition classification reassignment decision table 251, then the CPU 21 makes a decision whether the first ratio is at most the high utilization threshold 904 in the assignment condition classification reassignment decision table 251 and the second ratio is at least the low utilization threshold 905 in the assignment condition classification reassignment decision table 251 (step 1908). If the first ratio is at most the high utilization threshold 904 in the assignment condition classification reassignment decision table 251 and the second ratio is at least the low utilization threshold 905 in the assignment condition classification reassignment decision table 251, then the CPU 21 judges that the user does not use information processing devices so frequently and changes the assignment condition classification, for example, from “A to B” (step 1909). Unless the first ratio is at most the high utilization threshold 904 in the assignment condition classification reassignment decision table 251 and the second ratio is at least the low utilization threshold 905 in the assignment condition classification reassignment decision table 251, then the CPU 21 does not change the assignment condition classification and terminates the processing.

If the assignment condition classifications are not dispersed but biased to high priority classifications (such as A and B) by repeating the above-described assignment condition classification reassignment decision processing, then the coping capacity should be strengthened by introducing blade PCs additionally. If the assignment condition classifications are biased to low priority classifications (such as C and D), then it is possible to study the TCO reduction conducted by decreasing the number of blade PCs 1.

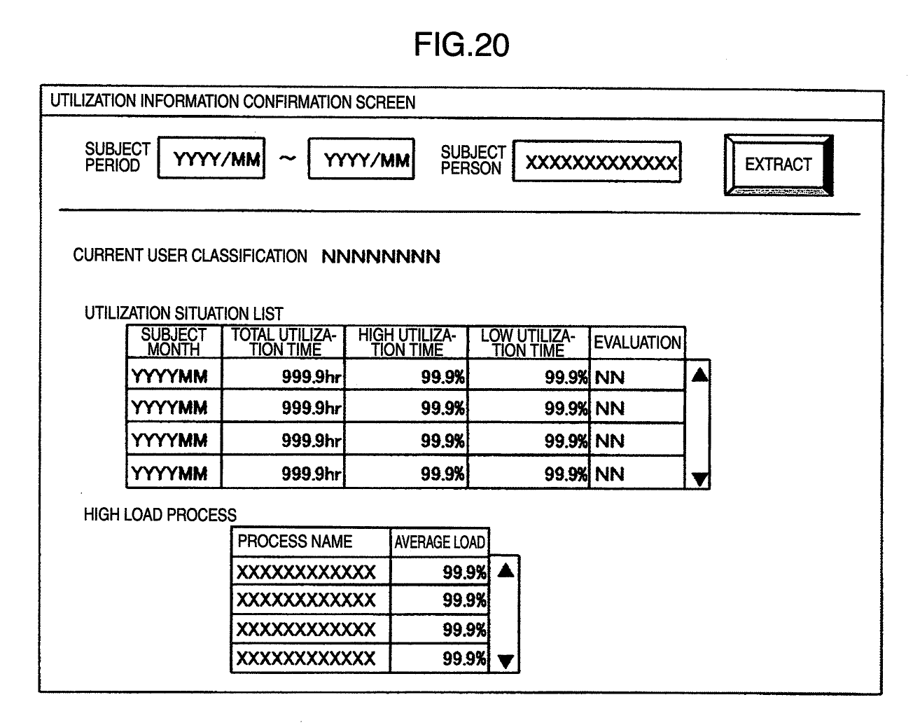

FIG. 20 is a diagram showing a screen example used by the manager to confirm the user's information processing device utilization situation. As shown in FIG. 20, the user's assignment condition classification, a utilization situation list in every month, and average load information of each process, over the subject period are displayed. As for the evaluation of the utilization situation list, a result of the assignment condition classification reassignment such as promotion in status, demotion or no change in the subject month is displayed.

Heretofore, an embodiment of the present invention has been described.

According to the present embodiment, prepared blade PCs are held down to a definite number, and consequently the TCO reduction effect can be anticipated.

In the above-described embodiment, the case where the terminal 6 receives the address of the management server 3 and the management server authentication information from the authentication device 7 and transmits an information processing device assignment request to the management server 3 as shown in steps 1501 to 1504 of FIG. 5 has been described. Alternatively, the authentication device may not be used. In the alternative configuration, the terminal 6 previously retains the address of the management server 3 and authentication information (a user ID and a password) input by the user through an authentication information input form displayed on the display 140 of the terminal 6 is transmitted to the management server 3 at the time of an information processing device assignment request.

Furthermore, in the above-described embodiment, the case where the address of an assigned information processing device is registered in the authentication information management table 245 at the time of assignment of the information processing device has been described. In an alternative configuration, for example, the terminal 6 retains an address transmitted from the management server and this address is transmitted to the management server 3 together with the management server authentication information at the time of information processing device assignment request.

In the above-described embodiment, the information processing system including the active directory server 4 has been described. Alternatively, each information processing device may have the function of the active directory server 4.

It should be further understood by those skilled in the art that although the foregoing description has been made on embodiments of the invention, the invention is not limited thereto and various changes and modifications may be made without departing from the spirit of the invention and the scope of the appended claims.

1. An information processing device assignment method in an information processing system including a plurality of information processing devices, a management server for managing the information processing devices, and a plurality of terminals, which are connected to each other via a network,
wherein
the management server receives an information processing device assignment request from one of the terminals via the network, determines an information processing device to be assigned to the terminal of assignment request origin on the basis of state information of assignment of the information processing devices to the terminals stored in a first storage unit and condition information of assignment of the information processing devices to users of the terminals stored in a second storage unit in response to the received assignment request, transmits destination information of the determined information processing device to the terminal of assignment request origin via the network, and updates a state of assignment of the information processing device to a terminal stored in the first storage unit from an unassigned state to a state indicating assignment to the terminal of assignment request origin,
the terminal of assignment request origin, after receiving destination information of the information processing device assigned to the terminal from the management server via the network, communicates with the information processing device having the destination information by using the received destination information, and
the information processing device communicates with the terminal to which the destination information of the information processing device has been transmitted from the management server via the network.

2. The information processing device assignment method according to claim 1, wherein
each of the information processing devices supervises a utilization situation of the information processing device and transmits utilization situation data obtained by the supervision to the management server via the network, and
the management server receives the utilization situation data from the information processing device and stores the received utilization situation data in a third storage unit.

3. The information processing device assignment method according to claim 2, wherein the management server changes conditions of assignment of the information processing devices to users of the terminals stored in the second storage unit on the basis of the utilization situation data stored in the third storage unit and predetermined reference values.

4. An information processing system including a plurality of information processing devices, a management server for managing the information processing devices, and a plurality of terminals, which are connected to each other via a network,
wherein
the management server comprises:
a first storage unit for storing state information of assignment of the information processing devices to the terminals;
a second storage unit for storing condition information of assignment of the information processing devices to users of the terminals;
an assignment request reception unit for receiving an information processing device assignment request from one of the terminals via the network;
an information processing device determination unit for determining an information processing device to be assigned to the terminal of assignment request origin on the basis of state information of assignment of the information processing devices to the terminals stored in the first storage unit and condition information of assignment of the information processing devices to users of the terminals stored in the second storage unit in response to the received assignment request;
a destination information transmission unit for transmitting destination information of the information processing device determined by the information processing device determination unit to the terminal of assignment request origin via the network; and
an assignment state update unit for updating a state of assignment of the information processing device to a terminal stored in the first storage unit from an unassigned state to a state indicating assignment to the terminal of assignment request origin, and
each of the terminals comprises:
an assignment request transmission unit for transmitting the information processing device assignment request to the management server via the network;
a destination information reception unit for receiving destination information of the information processing device assigned to the terminal from the management server via the network; and
a communication unit for communicating with the information processing device having the destination information by using the destination information received by the destination information reception unit, and
each of the information processing devices comprises a communication unit for communicating with the terminal to which the destination information of the information processing device has been transmitted from the management server via the network.

5. The information processing system according to claim 4, wherein
each of the information processing devices further comprises:
a supervision unit for supervising a utilization situation of the information processing device; and
a utilization situation data transmission unit for transmitting utilization situation data obtained as a result of the supervision conducted by the supervision unit to the management server via the network, and
the management server further comprises:
a utilization situation data reception unit for receiving the utilization situation data from the information processing device; and
a third storage unit for storing the utilization situation data received by the utilization situation data reception unit.

6. The information processing system according to claim 5, wherein the management server further comprises an assignment condition change unit for changing conditions of assignment of the information processing devices to users of the terminals stored in the second storage unit on the basis of the utilization situation data stored in the third storage unit and predetermined reference values.

7. A management server connected to a plurality of information processing devices and terminals via a network, the management server comprising:
a first storage unit for storing state information of assignment of the information processing devices to the terminals;
a second storage unit for storing condition information of assignment of the information processing devices to the terminals; and
a control unit responsive to reception of an information processing device assignment request from one of the terminals via the network, for determining an information processing device to be assigned to the terminal of assignment request origin on the basis of state information of assignment of the information processing devices to the terminals stored in the first storage unit and condition information of assignment of the information processing devices to users of the terminals stored in the second storage unit in response to the received assignment request, transmitting destination information of the determined information processing device to the terminal of assignment request origin via the network, and updating a state of assignment of the information processing device to a terminal stored in the first storage unit from an unassigned state to a state indicating assignment to the terminal of assignment request origin.

8. The management server according to claim 7, wherein upon receiving the utilization situation data of the information processing device from the information processing device via the network, the control unit stores the received utilization situation data in a third storage unit.

9. The information processing device assignment method according to claim 8, wherein the control unit changes conditions of assignment of the information processing devices to the terminals stored in the second storage unit on the basis of the utilization situation data stored in the third storage unit and predetermined reference values.
